(19) United States
(12) Patent Application Publication
(10) Pub. No.: US 2014/0317481 A1
(43) Pub. Date: Oct. 23, 2014

(54) ELECTRONIC DOCUMENT CREATION DEVICE, METHOD AND PROGRAM

(71) Applicant: Yuji Sawada, Osaka-shi (JP)

(72) Inventor: Yuji Sawada, Osaka-shi (JP)

(73) Assignee: SHARP KABUSHIKI KAISHA, Osaka-shi, Osaka (JP)

(21) Appl. No.: 14/347,792

(22) PCT Filed: Jul. 18, 2012
(86) PCT No.: PCT/JP2012/068206

§ 371 Date: Mar. 27, 2014

(30) Foreign Application Priority Data
Dec. 15, 2011 (JP) 2011-274615

(51) Int. Cl. G06F 17/24

(52) U.S. Cl. CPC G06F 17/24
USPC 715/202

(57) ABSTRACT

An electronic document creation device for creating trial contents of an electronic document is provided. When the electronic document creation device creates trial contents, a dummy page for maintaining a layout of a two-page spread is inserted in addition to a page selected so as to be included in the trial contents. Consequently, in the case of a page, the page is displayed on the right side also in the trial contents, similarly to an original electronic document.

### TECHNICAL FIELD

The present invention relates to a technique to create an electronic document.

### BACKGROUND ART

As to book editing, for example, Japanese Patent Laying-Open No. 06-180496 (PTD 1) discloses an “apparatus of processing data of imposed pages, which is capable of readily addressing page insertion and automatically processing two-page spreads for correct page imposition”. According to the apparatus of processing data of imposed pages, “page advancement management means 23 sequentially designates page numbers, to cause job data creation means 24 to perform the following processes for each page: first, reading page data to be allocated to the designated page; causing two-page spread attribute determination means 26 to determine whether the read page data is data of a normal page or data of a two-page spread: also, causing right/left attribute determination means 27 to determine whether the designated page is a page on the left side or a page on the right side; and, if the page data is data of a two-page spread, allocating corresponding portions of page data to a page having the designated page number in the two-page spread and a page on the other side thereof, respectively. In this case, when page data already exists on the other page, the page data of this page and subsequent pages is shifted sequentially to next pages by page data shifting means 28 ([Configuration] in [Abstract]).

### CITATION LIST

### Patent Document

PTD 1: Japanese Patent Laying-Open No. 06-180496

### SUMMARY OF INVENTION

### Technical Problem

In recent years, electronic books have become widely used, and editors of electronic books may create trial contents of these electronic books for promotion. Trial contents are a part of contents in main contents constituting an electronic book, and means contents created in advance as a sample by a publishing company of electronic books. Some pages of the main contents selected by an editor are selected and included in trial contents. In this case, in an electronic book like a magazine consisting of two-page spreads including pages arranged on the right and left sides, when only some of pages are selected, the layout may be changed, in which the page to be displayed on the right side in the main contents of the electronic book may be displayed on the left side in the trial contents, or the page to be displayed on the left side may be displayed on the right side in the trial contents. Accordingly, also for creating trial contents, a technique capable of maintaining the layout is required.

The present invention has been made in order to solve the above-described problems. An object of the present invention is to provide an electronic document creation device allowing easy creation of trial contents. An object of another aspect is to provide a method for creating an electronic document. An object of still another aspect is to provide a program for causing a computer to function as an electronic document creation device allowing easy creation of trial contents.

### Solution to Problem

An electronic document creation device according to one embodiment includes a storage device configured to store main contents consisting of a plurality of page images, a display device; a selection unit configured to accept selection of a page image to be included in sample contents from the page images, based on an operation for the electronic document creation device; an editing unit configured to create the sample contents by inserting a blank page in a page not included in the sample contents in order to maintain arrangement of the page images on right and left sides that are displayed in a state of a two-page spread on the display device; and an output unit configured to output the sample contents created by the editing unit.

Preferably, the editing unit is configured to include, in the sample contents, data for causing an information display terminal displaying an electronic document to display a screen for purchasing contents including details of the page not included in the sample contents, in response to access by the information display terminal to the page not included in the sample contents.

Preferably, the editing unit is configured to insert a page image designated in advance in the page not included in the sample contents.

Preferably, the editing unit is configured to: delete page images in a two-page spread including two pages arranged on the right and left sides when both of the pages on the right and left sides are not selected by the selection unit: insert the blank page in a not-selected page of the page images in the two-page spread, when one of the pages on the right and left sides is selected by the selection unit, and include the page images in the two-page spread without change in the sample contents when both of the page images in the two-page spread are selected by the selection unit.

Preferably, the electronic document creation device further includes a table-of-contents creation unit configured to create a table of contents of pages included in the sample contents, based on a result of selection by the selection unit.

Preferably, the table-of-contents creation unit is configured to create the table of contents so as, when a page included in the sample contents is selected, to display the selected page, and so as, when a page not included in the sample contents is selected, not to display the selected page.

Preferably, the editing unit is configured to include, in the sample contents, an indicator indicating that the page not included in the sample contents exists, in order for the information display terminal displaying the sample contents to show the indicator.

According to another embodiment, a method for a computer including a memory and a processor to create an electronic document is provided. This method includes the steps of: loading, by said processor, main contents consisting of a plurality of page images from the memory; accepting, by said processor, selection of a page image to be included in sample contents from the page images, based on an operation performed for the computer; creating, by said processor, the sample contents by inserting a blank page in a page not included in the sample contents in order to maintain arrangement of the page images on right and left sides that are displayed in a state of a two-page spread, and outputting, by said processor, the sample contents created.

According to still another embodiment, a program tbr causing a computer including a memory and a processor to function as an electronic document creation device is provided. The program causes the processor to perform the steps of loading main contents consisting of a plurality of page images from the memory; accepting selection of a page image to be included in sample contents from the page images, based on an operation performed for the computer, creating the sample contents by inserting a blank page in a page not included in the sample contents in order to maintain arrangement of the page images on right and left sides that are displayed in a state of a two-page spread; and outputting the sample contents created.

The foregoing and other objects, features, aspects and advantages of the present invention will become more apparent from the following detailed description of the present invention when taken in conjunction with the accompanying drawings.

### BRIEF DESCRIPTION OF DRAWINGS

FIG. 1 is a diagram showing the manner of use of an electronic document creation device 10 according to an embodiment of the present invention.

FIG. 2 is a block diagram showing the hardware configuration of a computer 200 functioning as electronic document creation device 10 or a contents provider 20.

FIG. 3 is a diagram showing the external appearance of an information display terminal 30.

FIG. 4 is a diagram showing details of the configuration of information display terminal 30.

FIG. 5 is a diagram showing the state where a page to be included in trial contents is selected from pages of an electronic document.

FIG. 6 is a diagram showing the state where pages 520, 530, 540, and 560 selected as pages to be included in the trial contents are simply combined.

FIG. 7 is a diagram showing the state where the present technical idea is applied to electronic document creation device 10 according to the present embodiment.

FIG. 8 is a diagram showing the state where information display terminal 30 is arranged in the lengthwise direction and in the widthwise direction.

FIG. 9 is a diagram showing the file configuration of the electronic document in a hard disk 5.

FIG. 10 is a diagram showing the configuration of a page information file 920.

FIG. 11 is a diagram showing the data structure of a table-of-contents information file 930.

FIG. 12 is a diagram showing the state where information display terminal 30 displays a table of contents of main contents.

FIG. 13 is a diagram showing the state where a display unit 110 of information display terminal 30 displays a table of contents of the trial contents.

FIG. 14 is a flowchart showing a part of a series of processes performed by a CPU 1 included in computer 200 functioning as electronic document creation device 10.

FIG. 15 is a diagram showing an example of a screen displayed on a monitor 8 of computer 200.

FIG. 16 is a flowchart showing a part of a page deletion process by electronic document creation device 10.

FIG. 17 is a flowchart showing a part of the process performed by CPU 1.

FIG. 18 is a diagram schematically showing the result of a process by a page deletion method according to the present embodiment.

FIG. 19 is a diagram schematically showing the result of a process by another page deletion method according to the present embodiment.

FIG. 20 is a flowchart showing a part of a process of automatically updating a table of contents.

### DESCRIPTION OF EMBODIMENTS

The embodiments of the present invention will be hereinafter described with reference to the accompanying drawings. In the following description, the same components are designated by the same reference characters. Names and functions thereof are also the same. Therefore, detailed description thereof will not be repeated.

[Manner of Use]

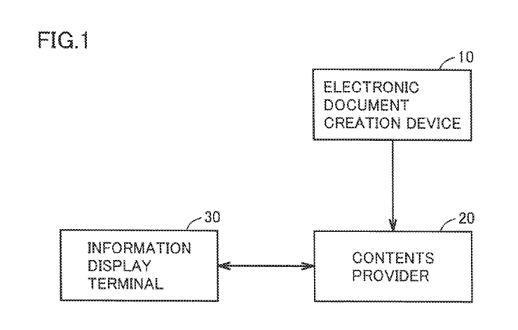

FIG. 1 is a diagram showing the manner of use of an electronic document creation device 10 according to an embodiment of the present invention. Electronic document creation device 10 is connected to a contents provider 20 for distributing contents. Electronic document creation device 10 causes a storage device of contents provider 20 to store the created electronic document. Based on a request from an information display terminal 30, contents provider 20 selectively transmits a sample of the stored electronic document and the entire electronic document to information display terminal 30. In the present embodiment, contents means, for example, an electronic document of a book, a magazine and the like.

Electronic document creation device 10 is implemented by a computer having a well-known configuration. Contents provider 20 is similarly implemented by a computer device having a well-known configuration. In another aspect, electronic document creation device 10 and contents provider 20 may be implemented by the same computer device.

Information display terminal 30 includes, for example, a smart phone, a tablet-type terminal, an electronic document reader, and the like.

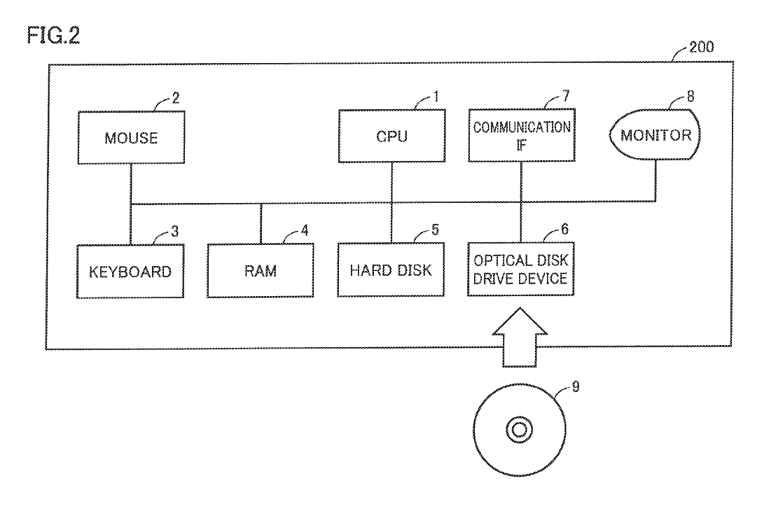

Referring to FIG. 2, the configuration of electronic document creation device 10 and contents provider 20 according to the present embodiment will be hereinafter described. FIG. 2 is a block diagram showing the hardware configuration of a computer 200 functioning as electronic document creation device 10 or contents provider 20.

Computer 200 is formed of main components including a CPU (Central Processing Unit) 1 executing a program, a mouse 2 and a keyboard 3 receiving an input of an instruction given by the user of computer 200, an RAM 4 storing data in a volatile manner that is generated by CPU 1 executing the program or that is input via mouse 2 or keyboard 3, a hard disk 5 storing data in a non-volatile manner, an optical disk drive device 6, a monitor 8, and a communication IF (Interface) 9. These components are mutually connected via a bus. A CD-ROM 9 and other optical disks are mounted on optical disk drive device 6. Communication IF 9 includes a USB (Universal Serial Bus) interface, a wired LAN (Local Area Network), a wireless LAN, a Bluetooth (registered trademark) interface, and the like, but not limited thereto.

The process in computer 200 is implemented by software executed by each hardware and CPU 1. Such software may be stored in hard disk 5 in advance. Furthermore, the software may be stored in CD-ROM 9 or other computer-readable nonvolatile data recording media, and distributed as a program product. Alternatively, the software may be provided as a program product that can be downloaded by the information provider connected to the Internet or other networks. Such software is read from the data recording medium by optical disk drive device 6 or other data readers, or downloaded through communication IF 7, and then stored once in hard disk 5. This software is read from hard disk 5 by CPU 1, and stored in RAM 4 in an executable program format. CPU 1 executes this program.

Each component forming computer 200 shown in FIG. 2 is commonly used. Therefore, the most essential part according to the present embodiment can also be regarded as a program stored in computer 200. Since the operation of each hardware of computer 200 is well known, detailed description thereof will not be repeated.

A data recording medium is not limited to a CD-ROM, an FD (Flexible Disk) and a hard disk, but may be a nonvolatile data recording medium fixedly carrying a program, such as a magnetic tape, a cassette tape, an optical disk (MO (Magnetic Optical Disc)/MD (Mini Disc)/DVD (Digital Versatile Disc)), and a semiconductor memory such as an IC card (Integrated Circuit) card (including a memory card), an optical card, a mask ROM, an EPROM (Electronically Programmable Read-Only Memory), an EEPROM (Electronically Erasable Programmable Read-Only Memory), a flash ROM, or the like.

The program referred herein may include not only a program directly executable by a CPU, but also a program in a source program format, a compressed program, an encrypted program, and the like.

In a certain aspect, hard disk 5 stores each of page images forming an electronic document. Monitor 8 displays an edit screen for creating an electronic document.

CPU 1 is configured as a setting unit to set arrangement of page images on the right and left sides based on the operation for computer 200. CPU 1 is configured as a selection unit to accept selection of page images to be included in the sample contents from the page images based on the operation for computer 200. CPU 1 is configured as an editing unit to create sample contents by inserting a blank page in a page not included in the sample contents in order to maintain arrangement of the page images on the right and left sides based on the arrangement setting. Communication IF 7 outputs the created sample contents. For example, communication IF 7 is configured to transmit the sample contents designated by information display terminal 30 to information display terminal 30 based on the request from information display terminal 30 connected to the Internet or other communication lines.

In another aspect, CPU 1 is configured to include data in the sample contents that is used for causing information display terminal 30 displaying an electronic document to display a screen for purchasing contents including details of each page not included in the sample contents, in response to access to the page not included in the sample contents by information display terminal 30.

In another aspect, CPU 1 is configured to insert a page image designated in advance in the page not included in the sample contents.

In another aspect, when both of pages on the right and left sides are not selected from the page images in a two-page spread including two pages arranged on the right and left sides, CPU 1 deletes the page images in the two-page spread. When one of the pages on the right and left sides is selected, CPU 1 inserts a blank page in the not-selected page of the page images in the two-page spread. When both of the page images in the two-page spread are selected, CPU 1 causes the page images in the two-page spread to be included in the sample contents as they are.

In another aspect, CPU 1 is configured as a table-of-contents creation unit to create a table of contents of the pages included in the sample contents based on the result of page selection.

In another aspect, CPU 1 is configured to create a table of contents so as, when a page included in the sample contents is selected, to display the selected page and so as, when a page not included in the sample contents is selected, not to display the selected page.

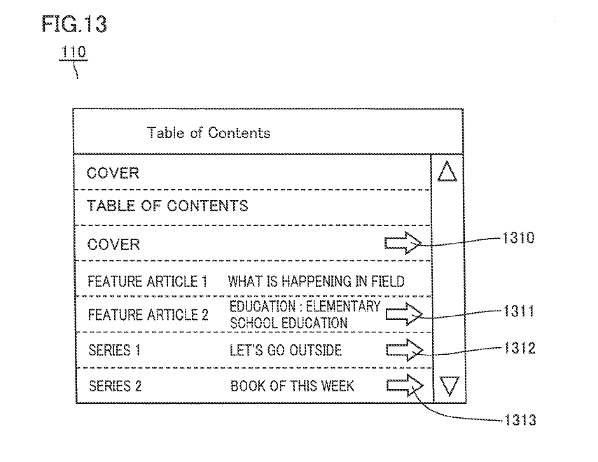

In another aspect, CPU 1 is configured to show an indicator (for example, arrows 1310, 1311, 1312, and 1313 shown in FIG. 13) indicating that a page not included in the sample contents exists, when the sample contents are displayed on information display terminal 30.

[Information Display Terminal]

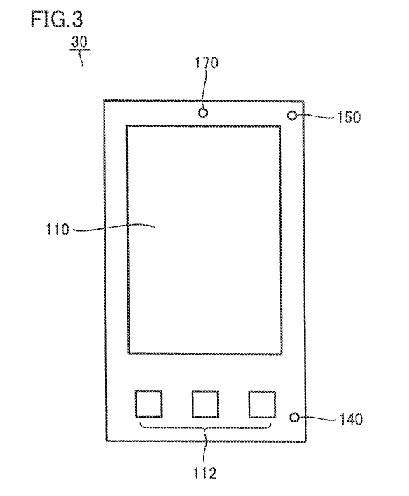

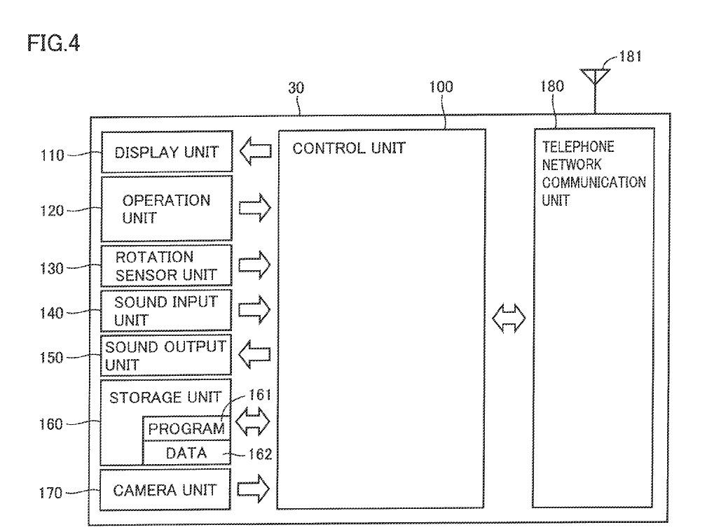

Referring to FIGS. 3 and 4, the configuration of information display terminal 30 according to the present embodiment will be hereinafter described. FIG. 3 is a diagram showing the external appearance of information display terminal 30. FIG. 4 is a diagram showing details of the configuration of information display terminal 30.

As shown in FIG. 3, information display terminal 30 includes a display unit 110, a key input unit 112, a sound input unit 140, a sound output unit 150, and a camera unit 170. In a certain aspect, information display terminal 30 is a tablet-type terminal, a smart phone, an electronic book reader terminal or other terminals, and serves as a terminal capable of displaying an electronic book or other contents.

As shown in FIG. 4, information display terminal 30 includes a control unit 100, an operation unit 120, a rotation sensor unit 130, a storage unit 160, a telephone network communication unit 180, and an antenna 181, in addition to the configuration shown in FIG. 3. Storage unit 160 stores a program 161 and data 162.

Control unit 100 controls the operation of information display terminal 30 according to the instruction given to information display terminal 30, or based on the instruction received through antenna 181, or based on establishment of the predetermined conditions in information display terminal 30. Control unit 100 is implemented as a processor, for example.

Display unit 110 displays an icon, information and the like based on the instruction by control unit 100. In a certain aspect, display unit 110 is implemented as a liquid crystal display device or an organic EL (Electro Luminescence) display, for example.

Operation unit 120 accepts an input of the operation performed by the user on information display terminal 30. Operation unit 120 is implemented, for example, as a touch panel provided in display unit 110, or as key input unit 112. Operation unit 120 accepts a signal in accordance with the operation, which is input to control unit 100. Control unit 100 executes an instruction based on the signal.

Rotation sensor unit 130 is implemented by a gyro sensor or the like, and detects the orientation and the like of the terminal. Rotation sensor unit 130 detects whether the terminal is displayed in the state arranged in the lengthwise direction or in the state arranged in the widthwise direction. The detection result is output to control unit 100.

Sound input unit 140 is implemented as a microphone, for example. Sound input unit 140 accepts an input of sound emitted to information display terminal 30, and transmits a signal in accordance with the sound to control unit 100. In another aspect, sound input unit 140 accepts sound emitted by the user of information display terminal 30 for operation, and transmits a signal in accordance with the sound to control unit 100. Control unit 100 executes start-up of a specific application or other operations in accordance with the sound.

Sound output unit 150 outputs a signal supplied by control unit 100 as a sound based on the instruction from control unit 100. In a certain aspect, sound output unit 150 is implemented as a speaker. In another aspect, sound output unit 150 is implemented as a terminal for accepting attachment of headphones. In still another aspect, sound output unit 150 can also be implemented as an FM (Frequency Modulation) transmitter, for example.

Storage unit 160 stores program 161 executed by control unit 100 or data 162 used by control unit 100. Storage unit 160 is implemented, for example, as a flash memory or other storage devices capable of carrying data in a non-volatile manner, or as an ROM (Read Only Memory) or other storage devices. In still another aspect, storage unit 160 is implemented as a memory card or other drive devices accepting attachment of an attachable and detachable recording medium.

Camera unit 170 takes a photograph of an object and outputs a signal in accordance with the taken image. In a certain aspect, camera unit 170 is implemented by a CMOS (Complementary Metal-Oxide Semiconductor) element, a CCD (Charge Coupled Device) element, a lens, or the like.

Telephone network communication unit 180 communicates with another telephone through a telephone line or other communication lines. Antenna 181 transmits and receives a signal for a telephone call, or transmits and receives a signal for communication.

[Creation of Trial Contents]

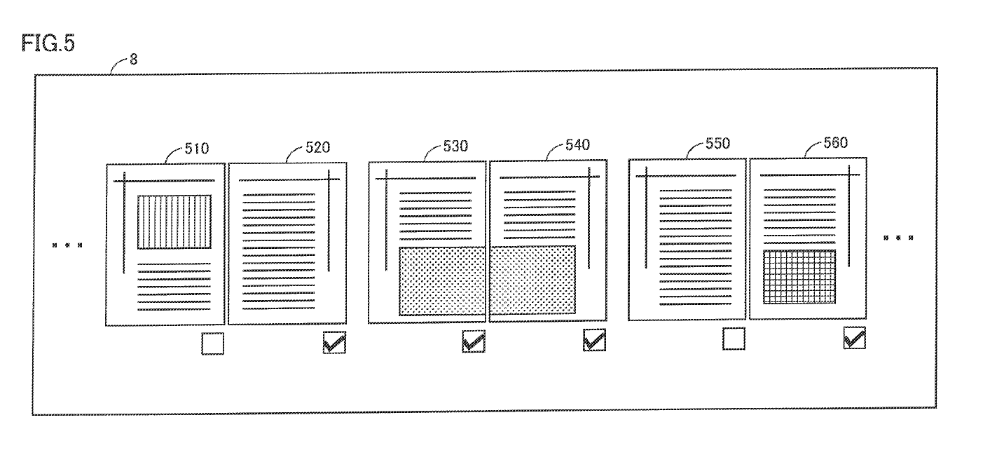

Referring to FIGS. 5 to 7, creation of trial contents that are sample contents of an electronic document will be hereinafter described. FIG. 5 is a diagram showing the state where a page to be included in trial contents is selected from pages of an electronic document.

In a certain aspect, monitor 8 displays each page of an electronic document. The data format of each page is for example a JPEG format or other image data formats. In the example shown in FIG. 5, monitor 8 displays pages 510, 520, 530, 540, 550, and 560 of the electronic document. Furthermore, a check box that can be marked by the user of electronic document creation device 10 is associated with each page and displayed thereon. For example, the user of electronic document creation device 10 inserts a check mark in each of the check boxes associated with pages 520, 530, 540, and 560. Then, when an input confirmation operation is carried out, electronic document creation device 10 determines that pages 520, 530, 540, and 560 marked with check marks are to be included in the trial contents. Then, based on this determination, electronic document creation device 10 inserts selected pages 520, 530, 540, and 560 in a file of the trial contents.

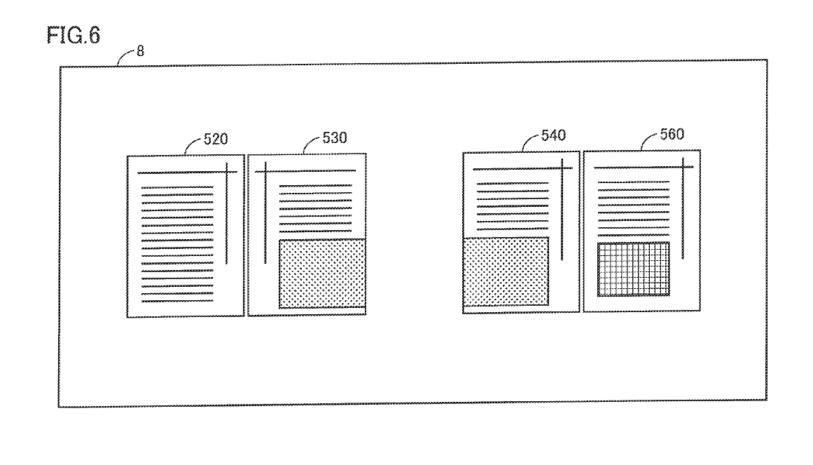

FIG. 6 is a diagram showing the state where pages 520, 530, 540, and 560 selected as pages to be included in trial contents are simply combined.

When pages 520, 530, 540, and 560 selected in the electronic document are selected as pages to be included in the trial contents, electronic document creation device 10 can create trial contents by combining only the selected pages.

In the case of page 520, for example, this page 520 is displayed as a page on the right side in the electronic document shown in FIG. 5. In the trial contents, on the other hand, page 520 is displayed as a page on the left side in the trial contents, as shown in FIG. 6.

In the case of page 530, this page is displayed as a page on the left side in the original electronic document. In contrast, page 530 is displayed as a page on the right side in the trial contents. Consequently, the arrangement of pages included in the trial contents may be different from the arrangement of pages included in the original electronic document. The same applies to page 540.

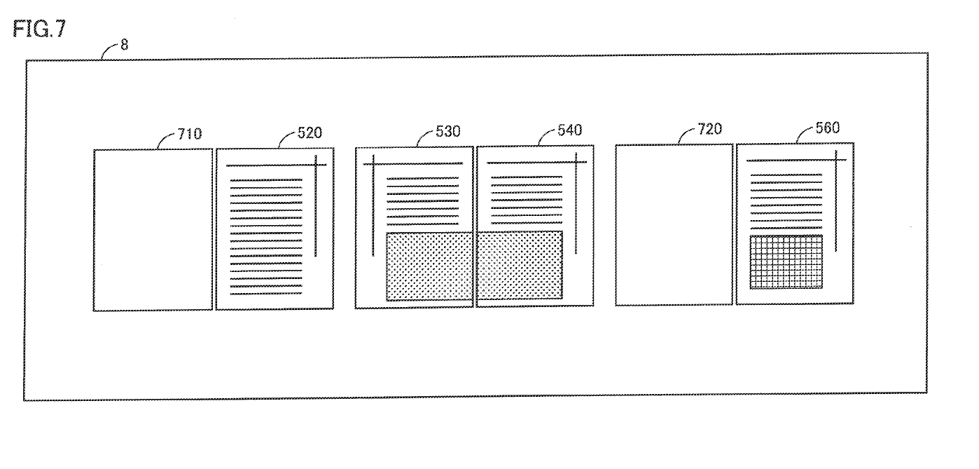

Accordingly, the layout of the pages in the trial contents may need to be the same as the layout of the pages in the original electronic document. FIG. 7 is a diagram showing the state where the present technical idea is applied to electronic document creation device 10 according to the present embodiment.

In other words, when trial contents are created, dummy pages 710 and 720 for maintaining the layout of two-page spreads are inserted, in addition to pages 520, 530, 540, and 560 selected to be included in the trial contents. Consequently, page 520 is displayed on the right side also in the trial contents, as in the original electronic document.

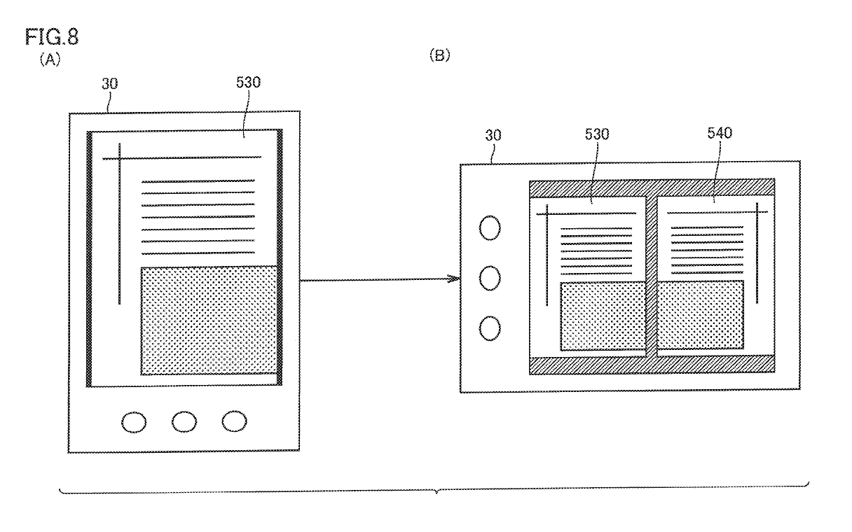

Referring to FIG. 8, another aspect of information display terminal 30 will be hereinafter described. FIG. 8 is a diagram showing the state where information display terminal 30 is arranged in the lengthwise direction and in the widthwise direction.

As shown in a state (A), in the case where information display terminal 30 having a lengthwise display region is arranged in the lengthwise direction, information display terminal 30 displays one page 530, for example. On the other hand, as shown in a state (B), in the case where the screen of information display terminal 30 is arranged in the widthwise direction, information display terminal 30 displays two pages 530 and 540 in the two-page spread state.

[Data Structure]

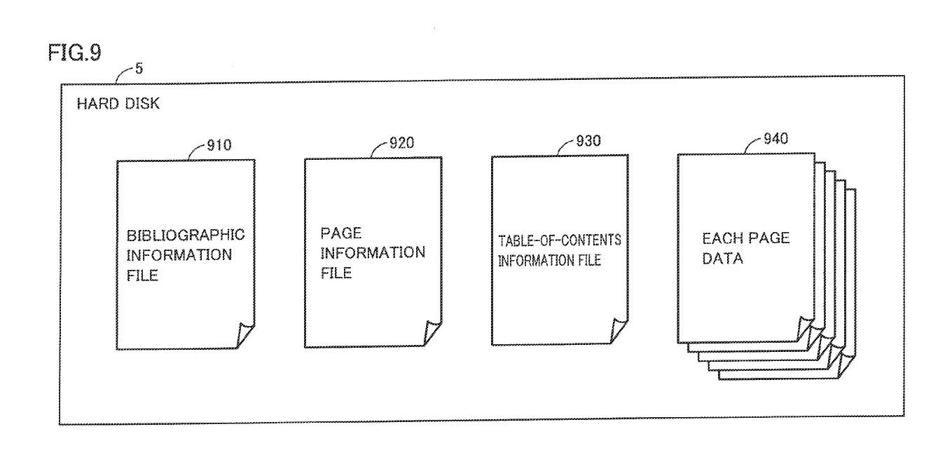

Referring to FIG. 9, the data structure of electronic document creation device 10 according to the present embodiment will be hereinafter described. FIG. 9 is a diagram showing the file configuration of an electronic document in a hard disk 5.

In a certain aspect, when electronic document creation device 10 creates an electronic document based on an operation performed by the user, the created electronic document is stored in hard disk 5. Specifically, hard disk 5 stores a bibliographic information file 910, a page information file 920, a table-of-contents information file 930, and each page data 940. Bibliographic information file 910, page information file 920, table-of-contents information file 930, and each page data 940 are associated with one another.

Bibliographic information file 910 includes a title, an author name, a publishing company name and other bibliographic information of the electronic document that are described in a predetermined format.

Page information file 920 includes the number of each page and other page information that constitute a file of the electronic document. Table-of-contents information file 930 includes a table-of-contents information of the electronic document. The table-of-contents information includes a title, page numbers and an author name of a specific article. In another aspect, page information file 920 may include a link leading to a purchase site for purchasing contents included in the electronic document.

Each page data 940 includes contents page created in an image data format for each page of the electronic document.

In a certain aspect, each of the original (main contents) and the trial contents of the electronic document is saved in the format shown in FIG. 9.

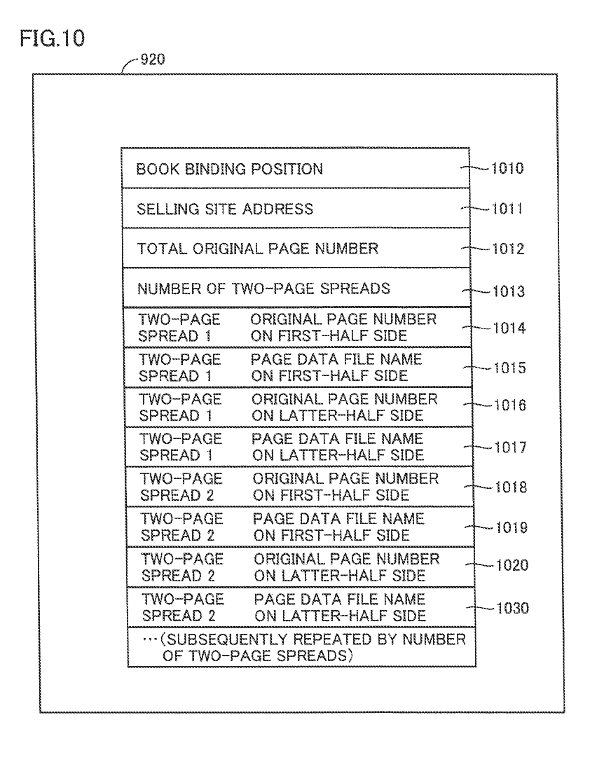

FIG. 10 is a diagram showing the configuration of page information file 920. Page information file 920 includes data items for the number of pages arranged in two-page spreads, as follows. Specifically, page information file 920 includes a book binding position 1010, a selling site address 1011, the total original page number 1012, the number of two-page spreads 1013, an original page number 1014 on the first-half side of a two-page spread 1, a page data file name 1015 on the first-half side of two-page spread 1, an original page number 1016 on the latter-half side of two-page spread 1, a page data file name 1017 on the latter-half side of two-page spread 1, an original page number 1018 on the first-half side of a two-page spread 2, a page data file name 1019 on the first-half side of two-page spread 2, an original page number 1020 on the latter-half side of two-page spread 2, and a page data file name 1030 on the latter-half side of two-page spread 2. In general, when the number of two-page spreads 1013 exceeds one, configurations of 1014 to 1017 are repeated by the number of two-page spreads 2013.

Book binding position 1010 shows whether a book is bound on the right side or the left side. In the case where the book is bound on the right side, pages are arranged from the right to the left in the two-page spread. In contrast, in the case where the electronic document is bound on the left side, pages are arranged from the left to the right in the two-page spread.

Selling site address 1011 includes a Web site address (URL: Uniform Resource Locator) where the main part of the trial contents in page information file 920 is available.

The total original page number 1012 shows the number of pages before deleting pages of the electronic document in electronic document creation device 10. For example, in the case of trial contents, the total original page number 1012 is equal to the number of pages of the main contents.

The number of two-page spreads 1013 represents the number in the case where pages arranged on the right and left sides are counted as one. When there is no page data on each of pages on the right and left sides in the trial contents, this two-page spread is not counted as the number of two-page spreads.

Original page number 1014 on the first-half side of two-page spread 1 represents the page number before deletion of pages. For example, it is numerically recorded in what page number counted from the first page (a cover page) the page concerned is located.

Page data file name 1015 on the first-half side of two-page spread 1 represents a file name of the page data in each of two-page spreads. Page data file name 1015 represents, for example, names of a JPEG (Joint Photographic Experts Group) file, a PNG (Portable Network Graphics) file and other image files. The arrangement of pages on the right and left sides is changed according to the setting of “book binding position 1010”. In a certain aspect, when some pages are deleted for trial in trial contents, the page data file name is indicated as “DELETE”, for example. Alternatively, when no page (contents) originally exists even before editing of page deletion, “NOP” or other predetermined fixed character strings are used in pace of a file name.

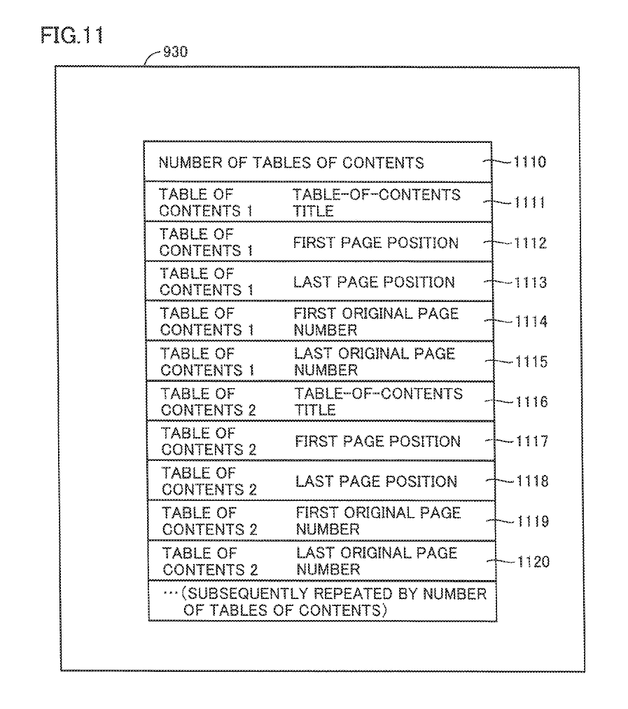

Referring to FIG. 11, the data structure of electronic document creation device 10 will be further described. FIG. 11 is a diagram showing the data structure of table-of-contents information file 930.

Table-of-contents information file 930 includes the number of tables of contents 1110, a table-of-contents title 1111, a first page position 1112, a last page position 1113, a first original page number 1114, a last original page number 1115, a table-of-contents title 1116, a first page position 1117, a last page position 1118, a first original page number 1119, and a last original page number 1120. In general, when the number of tables of contents 1110 exceeds one, configurations of 1112 to 1115 are repeated by the number of tables of contents 1110.

The number of tables of contents 1110 includes a record of the number of tables of contents included in the main contents or the trial contents. In a certain aspect, the number of tables of contents 1110 includes a record of the number of tables of contents in the original content before deletion of pages. For example, when the main contents represent a magazine, one article corresponds to one table of contents.

Table-of-contents titles 1111 and 1116 each include a record of a title of the table of contents.

First page position 1112 and last page position 1113 each represent a page position corresponding to the table of contents. The page position includes information in page information file 920 each indicating in what number of two-page spreads the page is located, and indicating whether the page is located on the first-half side or the latter-half side in the two-page spread. When the position corresponding to the table of contents does not exist in the contents, a predetermined special character string is stored in first page position 1112 or in last page position 1113. Alternatively, the memory region allocated for the data item is set to be blank.

First original page numbers 1114 and 1119 and last original page numbers 1115 and 1120 each represent the page number before deletion of pages that are not selected. In the case of the trial contents, the page number counted from the first page in the main contents is recorded in first original page numbers 1114 and 1119 and last original page numbers 1115 and 1120

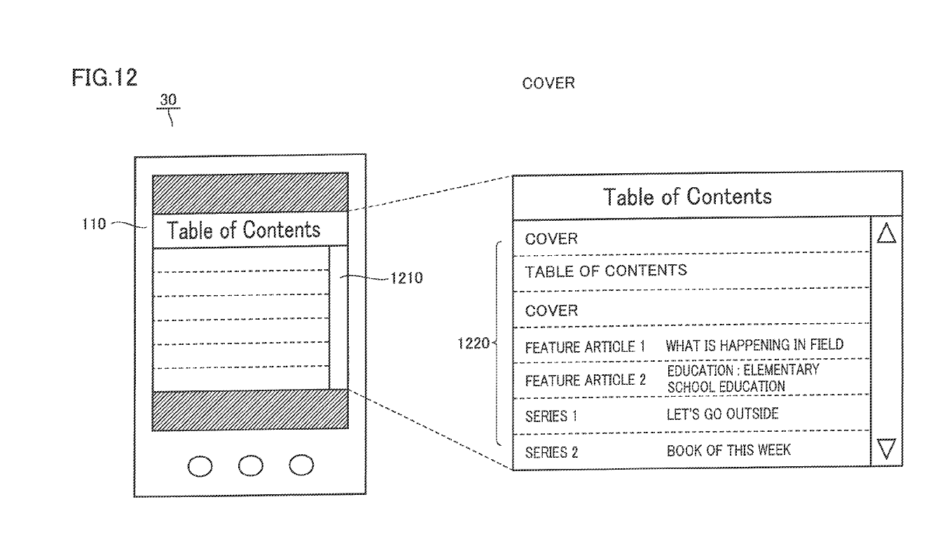

Referring to FIG. 12, a display example of the table of contents in the main contents will be hereinafter described. FIG. 12 is a diagram showing the state where information display terminal 30 displays a table of contents of the main contents.

In a certain aspect, information display terminal 30 causes display unit 110 to display the table of contents of the main contents. Display unit 110 displays a scroll bar 1210. When the table of contents does not fall within one screen of the display region in display unit 110, scroll bar 1210 is scrolled to display the screen, thereby allowing selection of the table of contents that has not been displayed on the screen.

When the user of information display terminal 30 selects one of tables of contents (for example, a cover, the first feature article, the second feature article and the like) from a table of contents 1220 by a tapping operation, the screen of information display terminal 30 jumps to a specific page of the selected table of contents.

Referring to FIG. 13, a display example of the table of contents in the trial contents will be hereinafter described. FIG. 13 is a diagram showing the state where display unit 110 of information display terminal 30 displays a table of contents of trial contents.

As a table of contents of the trial contents, display unit 110 displays a table of contents providing actual pages that are included as a reading sample, and a title of the table of contents providing actual pages that are not included as a reading sample. In this case, the title of the table of contents providing actual pages not included as a reading sample is represented for example in a gray-out state and represented so as to be distinguishable from the contents included as a reading sample.

In addition, based on the details of first page position 1112 in table-of-contents information file 930, it is determined by control unit 100 of information display terminal 30 whether the actual pages corresponding to each table of contents are included in the contents or not. In this case, last page position 1113 does not have to be used for this determination last page position 1113 is used, for example, in order to clarify the range of the article as contents.

The user may select the table of contents displayed in a gray-out state, that is, the table of contents in which corresponding pages are not included in the trial contents. In this case, information display terminal 30 displays that the selected table of contents is not included in the trial contents.

Furthermore, in another aspect, information display terminal 30 may cause display unit 110 to display a screen for making an inquiry about access to the site selling the contents. In this case, the user can purchase main contents only by checking the title without watching the trial contents. In this case, display unit 110 of information display terminal 30 displays arrows 1310, 1311, 1312, and 1313 in the items of each contents included as a reading sample, in order to clarify that a link to a selling site is established. Each arrow is linked to an online bookstore that distributes the contents. For example, when the user of information display terminal 30 selects an article marked with any of the arrows by performing a tap operation, information display terminal 30 accesses an electronic book selling site of the online bookstore via the link. This allows the user to purchase main contents including the article from the online bookstore. It is to be noted that the link is set at selling site address 1011 in page information file 920.

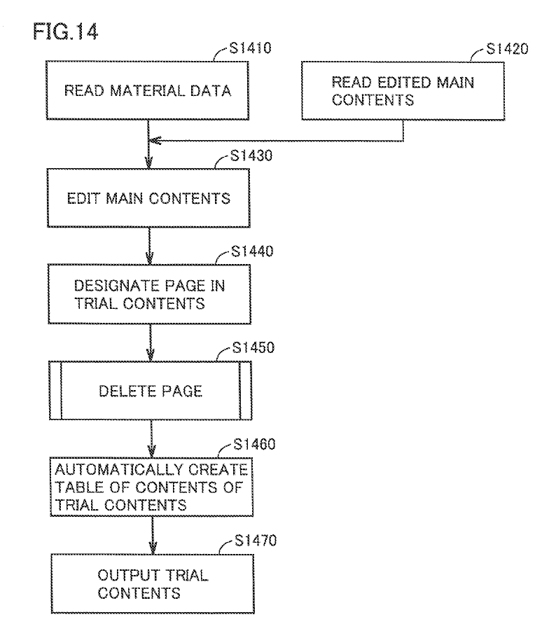

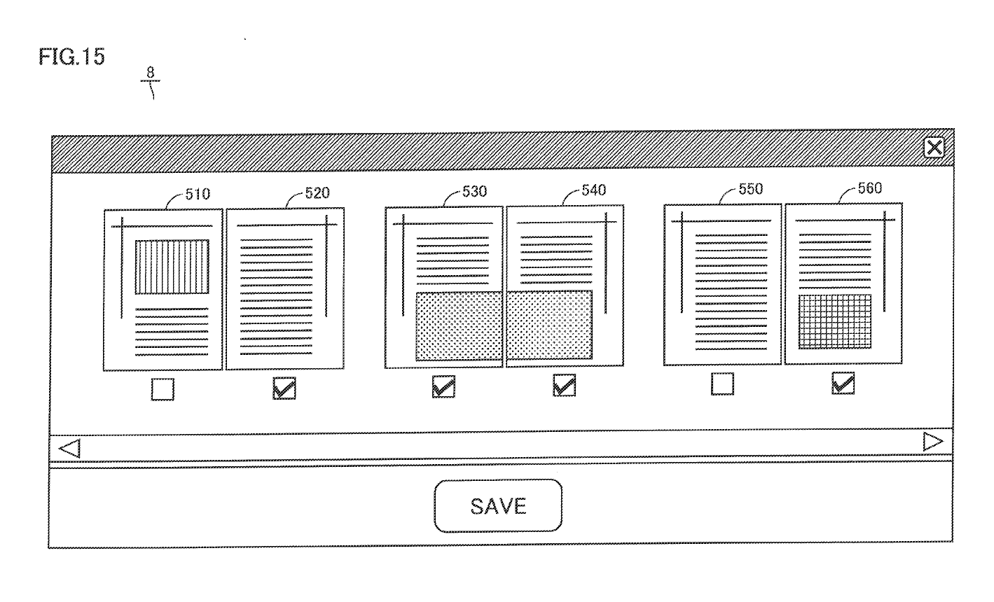

Referring to FIGS. 14 and 15, the control structure of electronic document creation device 10 according to the present embodiment will be hereinafter described. FIG. 14 is a flowchart showing a part of a series of processes performed by CPU 1 included in computer 200 functioning as electronic document creation device 10. FIG. 15 is a diagram showing an example of a screen displayed on monitor 8 of computer 200.

In step S1410, CPU 1 reads material data. Specifically, CPU 1 reads each page data of the main contents stored in hard disk 5 or other material data, and loads the same into RAM 4. When the material data is not in a format that can be treated as main contents, CPU 1 changes the format of the material data into a format that can be treated as main contents. For example, when only images in each page of the main part are valid and the material data is a PDF (Portable Document Format) file, CPU 1 converts each page of the PDF file into image data, and uses the image data in the subsequent processes.

In step S1430, CPU 1 edits main contents based on the operation performed by the user on electronic document creation device 10. Specifically, for example, CPU 1 accepts setting inputs of the direction in which the main contents are bound (bound on the right side/on the left side), the setting of arrangement of pages on the right and left sides, the setting of a table of contents (a table-of-contents title, the range of each table of contents (designated in page unit)), and the bibliographic information (a title, an author name, a publishing company name, and the like). Furthermore, CPU 1 accepts an input of “selling site address 1011” included in page information file 920 from the user, generates page information file 920 and stores the generated file in hard disk 5.

In step S1440, CPU 1 accepts designation of the page in the trial contents based on the input from the user. In this case, referring to FIG. 15, monitor 8 displays each of pages 510, 520, 530, 540, 550, and 560 in the main contents that are objects to be edited. The user of electronic document creation device 10 selects a page included in the trial contents from the main contents using a mouse or other input devices. Pages 520, 530, 540, and 560 are selected in the example shown in FIG. 15.

Again referring to FIG. 14, in step S1450, CPU 1 executes a page deletion process described later. When this process is executed, an unnecessary page is deleted in order to prevent displacement of pages arranged on the right and left sides in each page of the main contents, and then, a blank page is inserted as required.

In step S1460, CPU 1 automatically creates a table of contents for trial contents Specifically, CPU 1 creates table-of-contents data included in the trial contents from the table-of-contents data of the main contents in accordance with the page deletion process. CPU 1 updates first page positions 1112 and 1117 and last page positions 1113 and 1118 in table-of-contents information file 930 to correct positions in the trial contents (in what number of two-page spreads the page is located, and whether the page is located on the first-half side or the latter-half side in the two-page spread). In this case, when each of pages is deleted, CPU 1 stores the information in hard disk 5 indicating that these pages having been deleted.

In step S1470, CPU 1 outputs the edited and created trial contents. Specifically, CPU 1 outputs the data of the trial contents to hard disk 5 according to the format shown in FIGS. 9 to 11.

In another aspect, the main contents that have been edited may already be stored in hard disk 5. In this case, CPU 1 performs step S1420 in place of step S1410.

In other words, in step S1420, CPU 1 reads the main contents that have been edited. In the case where the edited main contents are already stored in hard disk 5, CPU 1 reads such main contents and loads them into RAM 4. When such main contents are read, a slight modification is made or, if not required, the process step mentioned above may be omitted in the process of editing the main contents in step S1430.

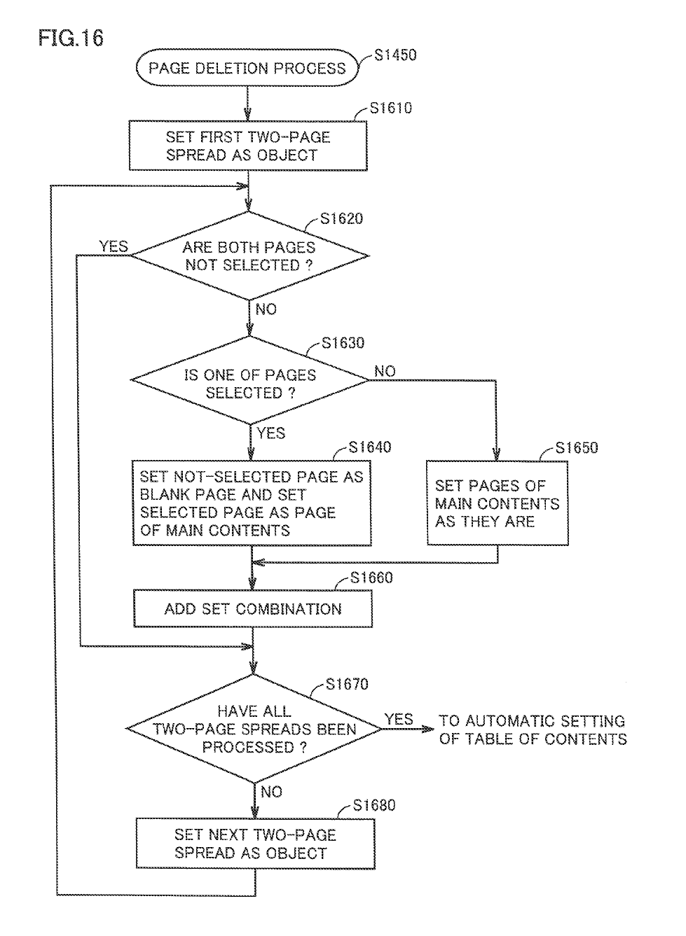

Referring to FIG. 16, the control structure of electronic document creation device 10 according to the present embodiment will be further described. FIG. 16 is a flowchart showing a part of a page deletion process by electronic document creation device 10.

In step S1610, CPU 1 sets the first two-page spread of the main contents as an object to be edited.

In step S1620, CPU 1 determines whether the pages constituting a two-page spread set as an object to be processed are to be added to the trial contents or not. This determination is made, for example, based on whether the check box in each page is checked by the user of electronic document creation device 10, as shown in FIG. 15. When determining that each of the pages is not selected (YES in step S1620), CPU 1 shifts control to step S1670. If not (NO in step S1620), CPU 1 shifts control to step S1630.

In addition, when one of two pages set as objects to be processed is blank and the other page is not selected, each of these two pages is not an object to be added. Accordingly, CPU 1 shifts control to step S1670.

In step S1630, based on an instruction given to electronic document creation device 10, CPU 1 determines whether only one of the pages is selected or not as an object to be added to the trial contents. When determining that only one of the pages is selected (YES in step S1630), CPU 1 shifts control to step S1640. If not (NO in step S1630), CPU 1 shifts control to step S1650. In addition, if one of the two pages set as objects to be processed is a blank page, CPU 1 shifts control to step S1640.

In step S1640, among paired pages set as objects to be processed, CPU 1 sets a not-selected page as a blank page and sets a selected page as page data for data of the main contents, so as to be set as a pair of pages constituting a two-page spread included in the trial contents. In addition, instead of setting the not-selected page as a blank page, a page image set in advance may be inserted. For example, for the not-selected page, it may be conceivable to automatically insert a page image introducing a site selling main contents or a page image describing the reason for deleting the page by showing a statement such as “a page deleted for an advertisement page”.

In step S1650, CPU 1 sets pages of the main contents as they are. In other words, since both of pages paired as objects to be processed are in the selected state, CPU 1 sets the paired pages as page data of the trial contents such that the relevant pages of the data in the main contents constitute a two-page spread in the trial contents. At this time, CPU 1 maintains the order of pages without change such that the pages arranged on the right and left sides are not replaced.

In step S1660, CPU 1 adds the pair of pages determined in steps S1640 and S1650 to the page data of the trial contents. At this time, CPU 1 associates the information on the page number (in what page number counted from the first page) in the main contents with the trial contents, and records the same. Thereby, the process for one pair of pages (two pages constituting one two-page spread) is ended.

In step S1670, CPU 1 determines whether the process for all two-page spreads has been ended or not. This determination is made, for example, based on whether the counter for calculating the number of times of the process performed for the pages set to be arranged in a two-page spread shows an upper limit value (for example, the last page of the two-page spreads). When determining that the process for all of the two-page spreads has been ended (YES in step S1670), CPU 1 shifts control to the process of automatically setting a table of contents (FIG. 21). If not (NO in step S1670), CPU 1 sets the next two-page spread as an object to be processed.

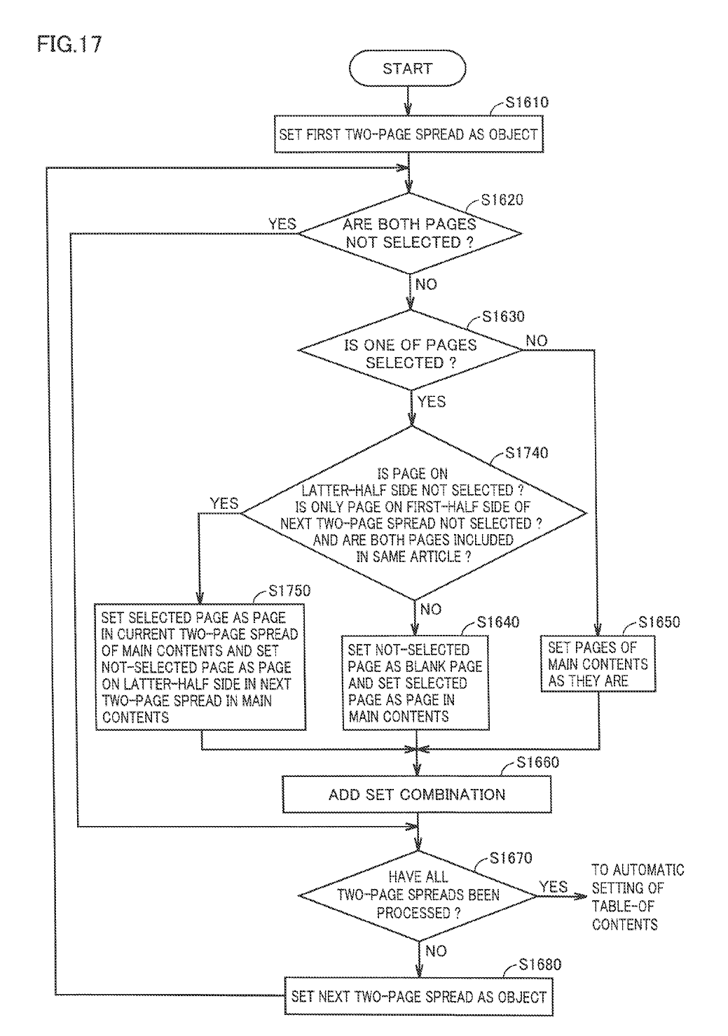

Referring to FIG. 17, page deletion in consideration of the range of the article in electronic document creation device 10 (the range of the table of contents) will be hereinafter described. FIG. 17 is a flowchart showing a part of the process performed by CPU 1. It is to be noted that the same step number is attached to the same process as that shown in FIG. 16. Therefore, detailed description thereof will not be repeated.

In step S1610, CPU 1 sets the first two-page spread in the main contents as an object to be edited.

In step S1620, CPU 1 determines whether the two-page spread set as an object to be processed is to be added to the trial contents.

In step S1630, CPU 1 determines whether or not only one of two pages is set as an object to be added to the trial contents. When determining that only one of the pages is set as an object to be added (YES in step S1630), CPU 1 shifts control to step S1740. If not (NO in step S1630), CPU 1 shifts control to step S1650.

In step S1740, CPU 1 determines whether the page on the latter-half side is not selected, whether only the page on the first-half side in the next two-page spread is not selected, and whether these pages are included in the same article or not. This determination is for example made by determining based on first original page numbers 1114 and 1119 and last original page numbers 1115 and 1120 finally included in table-of-contents information file 930 whether each page is included or not in any of the tables of contents. When determining that such conditions are satisfied (YES in step S1740), CPU 1 shifts control to step S1750. If not (NO in step S1740). CPU 1 shifts control to step S1640.

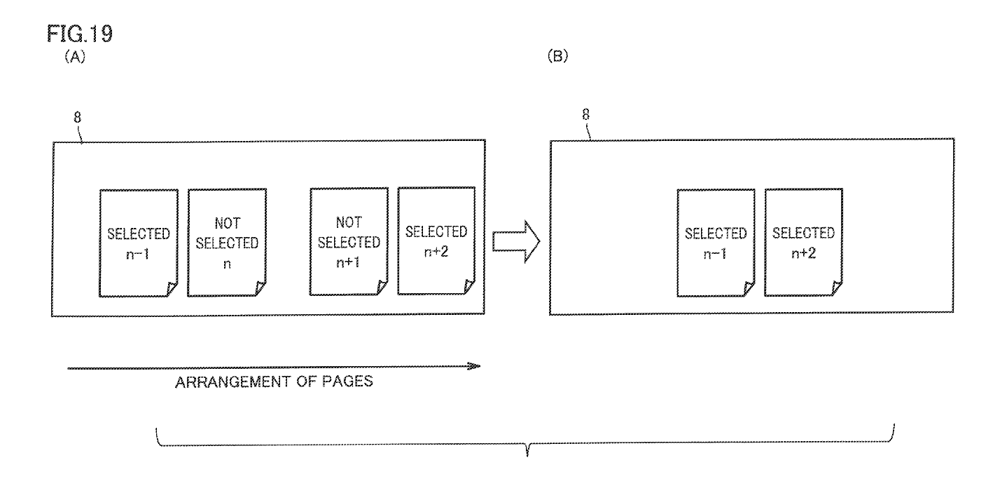

In step S1750, CPU 1 sets the selected page as a page in the current two-page spread of the main contents, and also sets the not-selected page as a page on the latter-half side in the next two-page spread in the main contents. The arrangement of pages at this time will be described later (FIG. 19).

Then, in step S1660, CPU 1 adds a combination that has been set and generates trial contents.

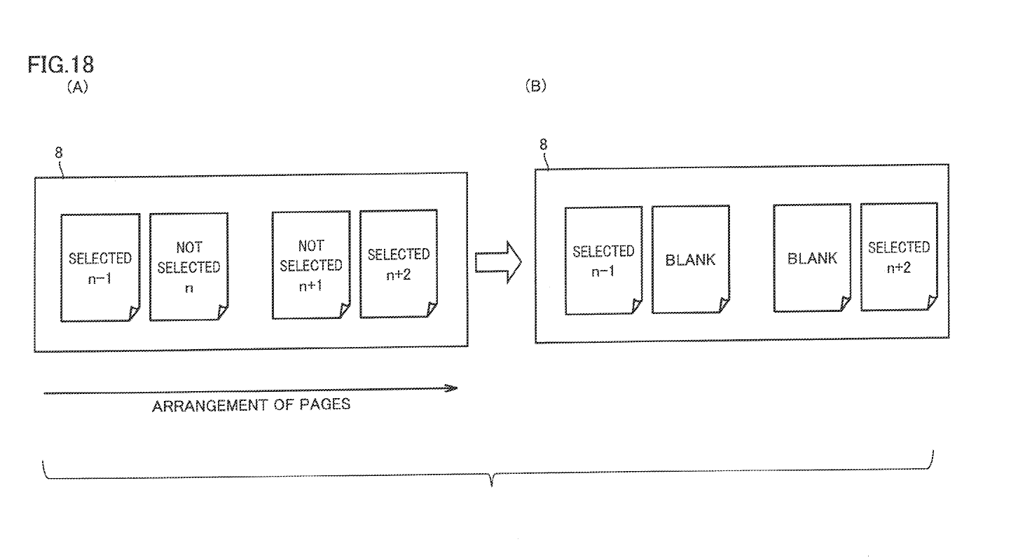

Referring to FIG. 18, details of step S1740 will be further described. FIG. 18 is a diagram schematically showing the process result obtained based on the flowchart in FIG. 16.

Referring to a state (A), in a certain aspect, for example, when an unnecessary page for trial contents, such as an advertisement page, is inserted in the middle of the document of the article consisting of a plurality of pages and this unnecessary page is not selected, a not-selected page (n) and a selected page (n−1) may be arranged side by side. In this case, when the not-selected page is not included in the trial contents, in a certain aspect, a predetermined blank page is inserted in place of the unnecessary page, as shown in a state (B). Consequently, since a blank page is inserted even in a series of articles, the reader of the trial contents may feel difficulty in reading the contents.

In contrast. FIG. 19 is a diagram schematically showing a conversion process for solving the above-described problem. When the process is performed according to the flowchart in FIG. 17 described above, this conversion process is performed. Referring to the state (A), in the case where objects to be edited in the trial contents exist in the same article, and when the pages in the main contents are arranged in a combination of selected→not-selected→not-selected→selected, electronic document creation device 10 according to the present embodiment does not insert a blank page that can be inserted for the not-selected page in the page data of the trial contents. This results in the trial contents including only a selected page (n−1) and a selected page (n+2), as shown in the state (B). Consequently, the reader of the trial contents can readily read the contents.

In addition, it is determined based on the information on the table of contents in the main contents whether continuous pages are to be included in the same article or not. In other words, in the table-of-contents information file of the main contents, based on first page positions 1112 and 1117 in the table of contents and last page positions 1113 and 1118 in the table of contents, it is determined whether these four pages to be processed are included in the same table of contents or not.

In a certain aspect, as a result of selecting the pages included in the trial contents, there may occur a combination of selected→not-selected→not-selected→selected. In step S1740, the combination of selected pages and not-selected pages is changed as shown in FIG. 19 only in the case of the same article. However, even in the case of not the same article, the combination of selected pages and not-selected pages can be changed as shown in the state (B) when there is a repeated sequence of selected→not-selected→not-selected→selected as in the state (A). This leads to an effect that the number of pages in the entire trial contents is decreased to decrease the number of times of page-turning, thereby improving the user's convenience.

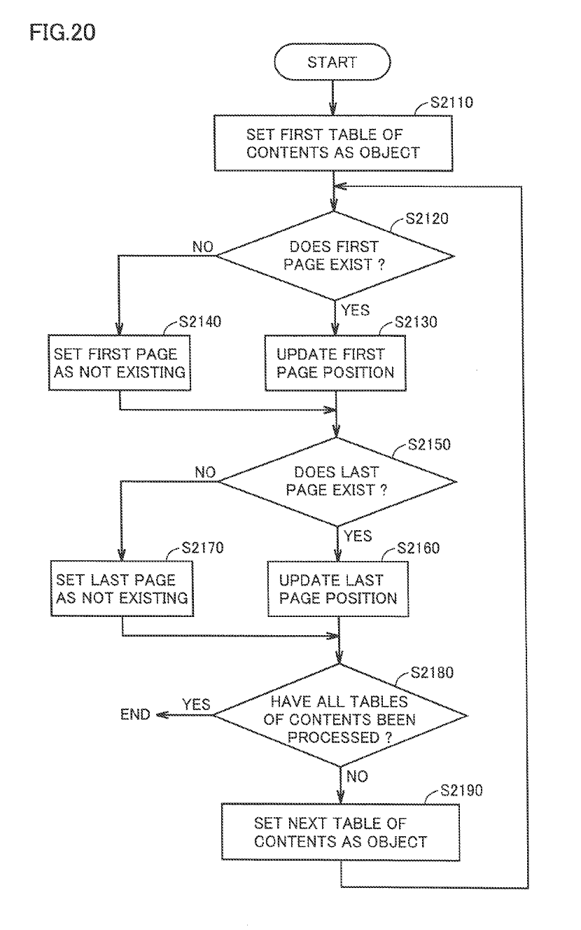

Referring to FIG. 20, the control structure of electronic document creation device 10 according to the present embodiment will be further described. FIG. 20 is a flowchart showing a part of a process of automatically updating a table of contents.

In step S2110, CPU 1 sets the first table of contents as an object to be processed for sequentially processing the tables of contents in the main contents.

In step S2120, CPU 1 determines whether the first page exists or not. Specifically, as to the table of contents set as an object to be processed, CPU 1 determines whether the page corresponding to the first page in the table of contents is included in the trial contents or not. When determining that the first page exists (YES in step S2120), CPU 1 shifts control to step S2130. If not (NO in step S2120), CPU 1 shifts control to step S2140.

In step S2130, CPU 1 updates the first page position. Specifically, when the first page exists, CPU 1 checks in what number of two-page spreads the first page is located in the trial contents, and also checks whether the first page is on the first-half side or on the latter-half side in the two-page spread.

In step S2140, CPU 1 sets the first page as not existing. Specifically, CPU 1 sets a blank or other special character strings indicating non-existence of the first page so as to be included as values of first page positions 1112 and 1117 of the table of contents included in table-of-contents information file 930.

In step S2150, CPU 1 determines whether the last page exists or not. Specifically, as to the table of contents as an object to be processed, CPU 1 determines whether the page corresponding to the last page in the table of contents is included in the trial contents or not. When determining that the last page exists (YES in step S2150), CPU 1 shifts control to step S2160. If not (NO in step S2150), CPU 1 shifts control to step S2170.

In step S2160, CPU 1 updates the last page position. Specifically, CPU 1 confirms in what number of two-page spreads the last page is located in the trial contents, and whether the last page is located on the first-half side or the latter-half side in the two-page spread, and then, stores the confirmation result in last page positions 1113 and 1118.

In step S2170, CPU 1 sets the last page as not existing. Specifically, CPU 1 sets a blank or a predetermined character string for indicating non-existence of the last page so as to be included in regions of last page positions 1113 and 1118 recorded in table-of-contents information file 930.

In step S2180, CPU 1 determines whether all of the tables of contents have been processed or not. When determining that all of the tables of contents have been processed (YES in step S2180), CPU 1 ends the control. If not (NO in step S2180), CPU 1 shifts control to step S2190.

In step S2190, CPU 1 sets the next table of contents as an object to be processed. Then, CPU 1 returns control to step S2120.

As described above, according to electronic document creation device 10 of the present embodiment, when trial contents are created from main contents, the layout is prevented from being changed by a not-selected page. Therefore, the reader of the trial contents can view the trial contents in such a state that the details are arranged in line with the same layout as that in the main contents.

Furthermore, in another aspect, the user may select the table of contents displayed in a gray-out state, that is, the page not included in the trial contents. In this case, information display terminal 30 causes display unit 110 to display that the selected page is not included in the trial contents, or display a screen for making an inquiry about access to the site selling the contents. Thereby, the user can easily purchase main contents including pages not included in the trial contents.

Although the present invention has been described and illustrated in detail, it is clearly understood that the same is by way of illustration and example only and is not to be taken by way of limitation, the scope of the present invention being interpreted by the terms of the appended claims.

### REFERENCE SIGNS LIST

1 CPU, 2 mouse, 3 keyboard, 4 RAM, 5 hard disk, 6 optical disk drive device, 8 monitor, 9 ROM, 10 electronic document creation device, 20 contents provider, 30 information display terminal, 100 control unit, 110 display unit, 112 key input unit, 120 operation unit, 130 rotation sensor unit, 140 sound input unit, 150 sound output unit, 160 storage unit, 161 program, 162 data, 170 camera unit, 180 telephone network communication unit, 181 antenna, 200 computer, 910 bibliographic information file, 920 page information file, 930 table-of-contents information file, 940 page data.

1. An electronic document creation device comprising:
a storage device configured to store main contents consisting of a plurality of page images;
a display device;
a selection unit configured to accept selection of a page image to be included in sample contents from said page images, based on an operation for said electronic document creation device;
an editing unit configured to create said sample contents by inserting a blank page in a page not included in said sample contents in order to maintain arrangement of the page images on right and left sides that are displayed in a state of a two-page spread on said display device; and
an output unit configured to output the sample contents created by said editing unit.

2. The electronic document creation device according to claim 1, wherein said editing unit is configured to include, in said sample contents, data for causing an information display terminal displaying an electronic document to display a screen for purchasing contents including details of the page not included in said sample contents, in response to access by said information display terminal to the page not included in said sample contents.

3. The electronic document creation device according to claim 1, wherein said editing unit is configured to insert a page image designated in advance in the page not included in said sample contents.

4. The electronic document creation device according to claim 1, wherein
said editing unit is configured to:
delete page images in a two-page spread including two pages arranged on the right and left sides when both of the pages on the right and left sides are not selected by said selection unit;
insert said blank page in a not selected page of the page images in said two-page spread, when one of said pages on the right and left sides is selected by said selection unit; and
include the page images in said two-page spread without change in said sample contents when both of the page images in said two-page spread are selected by said selection unit.

5. The electronic document creation device according to claim 1, further comprising a table-of-contents creation unit configured to create a table of contents of pages included in said sample contents, based on a result of selection by said selection unit.

6. The electronic document creation device according to claim 5, wherein said table-of-contents creation unit is configured to create said table of contents so as, when a page included in said sample contents is selected, to display said selected page, and so as, when a page not included in said sample contents is selected, not to display said selected page.

7. The electronic document creation device according to claim 1, wherein said editing unit is configured to include, in said sample contents, an indicator indicating that the page not included in said sample contents exists, in order for the information display terminal displaying said sample contents to show said indicator.

8. A method for a computer including a memory and a processor to create an electronic document, said method comprising:
loading, by said processor, main contents consisting of a plurality of page images from said memory;
accepting, by said processor, selection of a page image to be included in sample contents from said page images, based on an operation performed for said computer;
creating, by said processor, said sample contents by inserting a blank page in a page not included in said sample contents in order to maintain arrangement of said page images on right and left sides that are displayed in a state of a two-page spread; and
outputting, by said processor, said sample contents created.

9. A non-transitory recording medium storing a program for causing a computer including a memory and a processor to function as an electronic document creation device, said program causing said processor to perform:
loading main contents consisting of a plurality of page images from said memory;
accepting selection of a page image to be included in sample contents from said page images, based on an operation performed for said computer;
creating said sample contents by inserting a blank page in a page not included in said sample contents in order to maintain arrangement of said page images on right and left sides that are displayed in a state of a two-page spread; and
outputting said sample contents created.
